(19) United States
(12) Patent Application Publication
(10) Pub. No.: US 2004/0265591 A1
(43) Pub. Date: Dec. 30, 2004

(54) Connecting pieces for carbon material electrodes

(76) Inventors: Wilhelm Frohs, Allmannshofen (DE); Klaus-Peter Brehler, Bad Ischl (AT); Michael Heine, Allmannshofen (DE)

Correspondence Address: LERNER AND GREENBERG, PA, P O BOX 2480, HOLLYWOOD, FL, 33022-2480, US

(21) Appl. No.: 10/806,514

(22) Filed: Mar. 22, 2004

(30) Foreign Application Priority Data
Mar. 20, 2003 (DE) 103 12 370.9

(51) Int. Cl. B32B 9/00; C01B 31/04

(52) U.S. Cl. 428/408; 264/82; 264/136; 264/137; 264/29.2; 264/29.1; 264/29.7; 264/148

(57) ABSTRACT

Connecting pieces for carbon material electrodes include carbon fibers. The fibers are oxidatively activated carbon fibers which additionally have a carbonized coating. The carbonized coating is a carbonization product of a coating material selected from wax, pitch, natural resins, thermoplastic and thermosetting polymers.

### BACKGROUND OF THE INVENTION

### Field of the Invention

The invention relates to connecting pieces for carbon material electrodes. In particular, the invention relates to connecting pieces that are produced by mixing cokes, pitches, and carbon fibers to provide a mass, and by shaping the material mass. The shaped pieces are used for connecting carbon material electrodes, in particular graphite electrodes.

Carbon material electrodes, in particular graphite electrodes, are used in electric arc furnaces in the steel industry. The electrodes consist of individual cylindrical elements connected to one another, further elements being added in each case depending on the firing. The electrodes are usually connected to one another mechanically and in an electrically conductive manner by connecting pieces (also referred to as connecting pins, connecting nipples, and electrode nipples). Here, the connecting pieces have the shape of a double cone (two truncated pyramids joined to one another at the base) having threads on the lateral surfaces, which fit into corresponding recesses of the cylindrical electrodes, which recesses are formed centrally in the end faces.

Owing to the thermal load, it is necessary to adapt the thermal expansion of the connecting pieces and of the electrodes to one another in such a way as to prevent the formation of stresses which may lead to fracture or other damage at the connecting point. In the past, connecting pieces reinforced with carbon fibers have been proposed. For example, U.S. Pat. No. 4,998,709 describes graphite connecting pieces that are reinforced by carbon fibers which are obtained from mesophase pitch and are present in a proportion by mass of from 8 to 20% in the molding material used for the production. International PCT publication WO 01/62667 describes a similar process, but the fibers likewise obtained from mesophase pitch have a lower modulus of elasticity and are used in a smaller proportion by mass (from 0.5 to 5% in the molding material). This process leads to a reduction in the coefficient of thermal expansion in the direction of extrusion and of the main axis of the connecting piece.

The stresses usually occurring in fiber-reinforced materials are due to the different coefficients of thermal expansion of fibers and matrix. Carbon fibers are practically dimensionally stable in the fiber direction (i.e. the coefficient of thermal expansion is small and negative), whereas, for example, in the case of glassy carbon this coefficient is of the order of magnitude of 3·10⁻⁶·K⁻¹.

In the investigations on which the present invention is based, it has been found that further improvement compared with the above-mentioned prior art processes (U.S. Pat. No. 4,998,709 and WO 01/62667) can be achieved if carbon fibers whose surface has been treated before mixing into the molding material and has been provided with a polymer coating are used in the molding material for the production of the connecting pieces. Connecting pieces according to the invention have a reduced longitudinal (i.e., in the direction of the axis of the cylindrical electrode and of the connecting piece) coefficient of thermal expansion and increased strength. Owing to these properties, the connecting pieces according to the invention withstand not only the carbonization temperatures below 1000° C. but also a subsequent graphitizing treatment at above 3000° C.

It has become known in the art that carbon fibers can be anodically oxidized in an electrolyte solution (J. B. Donnet and R. C. Bansal, Carbon Fibers, Marcel Dekker Inc. New York (1990)). In that surface treatment, oxygen-containing groups form on the fiber surface, as a rule strongly or weakly acidic carboxyl groups and hydroxyl groups, C—H groups activated by carbonyl groups (C—H acidic groups), and basic pyrone-like surface groups (H. P. Boehm, E. Diehl, W. Heck, R. Sappok, Angew. Chem. 76 (1964), 742; B. R. Puri, in Walker: Chemistry and Physics of Carbon, Vol. 6, Marcel Dekker, New York (1971), 191).

Oxygen groups can be produced on the fiber surface also by thermal oxidation without the necessity of subsequent washing out for removing electrolytes. Oxygen in various concentrations, oxygen-halogen mixtures, ozone, carbon dioxide or oxides of nitrogen are described as an oxidation medium. A detailed discussion of these topics is found in J. Cziollek (“Studien zur Beeinflussung des Verstärkungsverhaltens von Kohlenstoffasern durch Oberflächenbehandlung der Fasern und durch Verwendung eines Kohlenstoff/Kohlenstoff-Skelettes als Verstärkungskomponente” [Studies on influencing the reinforcing behavior of carbon fibers by surface treatment of the fibers and by the use of a carbon/carbon skeleton as a reinforcing component], Thesis, University of Karlsruhe (1983), p. 40 et seq.).

In the case of carbon fiber-reinforced carbon (“CFC”), reduced reactivity of the fiber surface is regarded as a basic requirement for good utilization of the fiber properties. The reduced reactivity is intended to enable the matrix to shrink away from the fiber surface. The shrinkage cracks are then filled by repeated reimpregnation/recarbonization steps (impregnation, for example, with pitches and combustion in the absence of oxidizing agents). Consequently, carbon bonding bridges between fiber surface and matrix are produced (J. Cziollek, op. cit.). The restoration of the weakened fiber/matrix adhesion brought about by newly created surface groups as a result of the reimpregnation step has also been discussed (K. H. Giegl: “Studien zur Oberflächenchemie von Kohlenstoffasern und zur Entwicklung von Kohlenstoff-Hohlfasern” [Studies of the surface chemistry of carbon fibers and of the development of hollow carbon fibers], Thesis, University of Karlsruhe (1979)).

In contrast with these experimental findings in the case of CFC composites, an oxidative surface treatment of the fibers in the present invention has surprisingly proved to be advantageous for the properties of a composite produced therewith.

The present invention therefore relates to connecting pieces for carbon material electrodes, the connecting pieces containing carbon fibers whose surface has been oxidatively activated and which additionally have a carbonized coating. The surface coating is the carbonization product of a coating material (sizing) selected from wax, pitch, natural resins, thermoplastic and thermosetting polymers.

The invention furthermore relates to a process for the production of connecting pieces that contain the fibers treated according to the invention.

With the foregoing and other objects in view there is provided, in accordance with the invention, a connecting piece for carbon material electrodes. The connecting piece includes carbon fibers having oxidatively activated surfaces, and an added carbonized coating. The carbonized coating is a carbonization product of a coating material selected from the group consisting of wax, pitch, natural resins, thermoplastic polymers, and thermosetting polymers.

In the process according to the invention, the surface of the carbon fibers is activated by oxidation in a first step, the fibers are then provided, in a second step, with a surface coating comprising a coating material selected from wax, pitch, natural resins or thermoplastic or thermosetting polymers, the coated fibers are optionally treated in a third step at a temperature of from 750 to 1300° C. for carbonization of the coating, are mixed in a fourth step with coke having a mean particle size in the range from 0.05 to 4 mm, pitch having a softening temperature in the range from 70° C. to 150° C. and optionally further additives and shaped to give cylindrical bodies, the cylindrical moldings are carbonized and then graphitized in a fifth step, and the graphitized moldings are turned, in a sixth step, to give the connecting pieces having threads.

It is preferable to use carbon fibers in the form of fiber tow comprising from 1000 to 60,000 individual filaments, which, after the third process step, are cut to give short fibers having an average length of from 0.5 to 40 mm.

It is furthermore preferable to use carbon fibers in the form of heavy tow comprising from 40,000 to 2,000,000 individual filaments, which, after the third process step, are cut to give short fibers having an average length of from 0.5 to 40 mm.

It is furthermore preferable if the activated carbon fibers are coated, in the second step, in an aqueous or solvent-containing bath containing a dispersion or solution of a coating material selected from wax, pitch, natural resins or thermoplastic or thermosetting polymers.

It is furthermore preferable if the coated carbon fibers are treated, in the third step, at a temperature of from 900 to 1200° C. for carbonization of the coating.

It is furthermore preferable if, in the fourth step, a mixture containing for each 100 kg of coke, from 10 to 40 kg of a pitch and from 0.2 to 20 kg of carbon fibers is prepared.

It is furthermore preferable to add, as further additive, from 0.1 to 1 kg of an iron oxide pigment having a mean particle size of from 0.1 to 2 μm.

The surface coating is effected in particular using polymers which have a sufficient carbon yield at carbonization temperatures of, preferably, from about 750 to about 1300° C. Polyurethane resins, phenol resins and pitches having a C residue of at least 40% of the mass of the coating material used are particularly suitable.

The carbonization of the coating material can be effected in a thermal treatment step prior to mixing into the molding material, or preferably simultaneously with the combustion after green production.

Carbon fibers which are obtainable by carbonization of oxidatively stabilized polyacrylonitrile fibers in a known manner are preferably used. A thermal treatment of the fibers in the range from 1500° C. to the graphitizing temperature (1800° C. to about 3000° C., in some cases also above 3000° C.) prior to mixing in can be dispensed with. The modulus of elasticity of the fibers is preferably from 200 to 250 GPa.

The surface activation of the carbon fibers is effected by oxidation in an aqueous bath or by an oxygen-enriched gas stream at a temperature of from 400 to 600° C., the gas stream also serving for fanning out the fiber tow. In a preferred manner, it is also possible to oxidize the carbon fibers electrochemically, i.e. anodically in aqueous baths. Aqueous solutions of salts of oxidizing acids, such as nitrates, sulphates, chlorates, bromates and iodates, and the stated acids themselves are suitable as the oxidation bath; solutions which contain volatile oxidizing agents are preferred, the reduction products of these oxidizing agents preferably likewise being volatile. Here, substances which are defined as being volatile are those which are removed completely or substantially completely (with an evaporation residue which is not more than 0.5% of the mass of the treated fibers) on drying the treated fibers, for example in an air stream or on godets. Particularly preferred oxidizing agents are oxidizing acids, such as nitric acid, chloric acid or mixtures of these with neutral or salt-like inorganic oxidizing agents, such as hydrogen peroxide, chromates, permanganates and hypochlorites (KMnO₄/H₂SO₄, K₂Cr₂O₇/H₂SO₄, HOCl/H₂O/NaOCl). Mixtures of nonoxidizing acids with salt-like oxidizing agents are also suitable, for example the mixtures of hydrochloric acid and chlorates, known as euchlorine. In an electrochemical (anodic) oxidation, it is sufficient to establish adequate conductivity by dissolving acids, bases or salts in water.

After an electrochemical treatment (anodic oxidation) and with the use of oxidizing solutions (in particular salt solutions), it is necessary to wash the fiber tow with demineralized water, preferably at least two baths being arranged in series. The acid-treated fibers may also be washed, it being possible to omit the drying step.

The carbon fibers activated in this manner with oxygen-containing groups are then provided with the abovementioned surface coating, the dried or only washed fibers being passed through an aqueous impregnating bath, the excess solution containing coating materials being squeezed out in a known manner, and the fiber tow being dried, for example on heated godets.

The impregnating bath is preferably an aqueous formulation of said coating materials, for example an aqueous dispersion of waxes, in particular polyolefin waxes based on polyethylene or polypropylene, and montan waxes, or waxes synthesized by esterification of fatty alcohols with long-chain fatty acids having 12 to 40 carbon atoms. Furthermore, it is possible to use dispersions of polyurethane resins, of activated polyolefins (activated, for example, by grafting with maleic anhydride) or the copolymers thereof (for example with vinyl alcohol or vinyl acetate) or of phenol resins. It is also possible to treat the activated carbon fibers with organic compounds, in particular those based on pitches, dissolved in organic solvents. Pure pitches in a suitable low-viscosity form may also be used for the coating.

The concentrations of the coating formulations are usually such that a solids mass fraction of from 0.5 to 30%, originating from the coating, results on the fiber surface. A range of from 3 to 15% is preferred. This results in a mass fraction of, preferably, from 0.2 to 15% of the carbonized coating on the fibers.

Carbon fibers based on (carbonized) polyacrylonitrile are preferably used, since it has been found that these undergo the least damage by the mixing and shaping process on mixing to give the molding materials according to the invention. Their modulus of elasticity is as a rule not as high as that of carbon fibers based on mesophase pitch. This means lower rigidity and therefore also less sensitivity to shearing. Both the additionally applied coating and the conversion of this coating into a carbon layer lead to additional mechanical protection.

It was observed that the comminution of the fibers on mixing in is substantially reduced compared with the HM fibers (high-modulus fibers) sensitive to shearing. The degree of utilization of the amount of fibers used is thus higher, leading to a further cost benefit in addition to the lower costs of the HT fibers (high-tenacity fibers).

The meterability of the fiber bundle cut into short fibers (preferably having an average length of from 0.5 to 40 mm) is also improved by the sizing applied. Uncoated individual filaments having lengths of more than 2 mm tend to agglomerate and therefore cannot be metered in a controllable manner.

The fiber tows used preferably have from 1000 to 60,000 individual filaments, and multifilament tows based on heavy tow having more than 40,000 filaments and up to 2,000,000 filaments are also preferred.

It is also possible for the carbon fibers to be present in the form of parallel filaments (so-called “UD tapes”), woven fabrics, warp-knitted fabrics, knitted fabrics and/or nonwoven fabrics.

The connecting pieces according to the invention preferably have a linear coefficient of thermal expansion in the extrusion direction of from −0.5 to +0.1 μm/(K·m). The extrusion direction is the direction parallel to the lateral surface of the generally cylindrically shaped blanks which, after the carbonization and combustion, are processed by turning or milling and into which the required threads are cut. Perpendicular to the extrusion direction, the linear coefficient of thermal expansion is preferably from 1.7 to 2.1 μm/(K·m).

The mass fraction of carbon fibers in the connecting pieces is preferably from 0.2 to 10%.

It was surprisingly found that connecting pieces which were produced using such carbon fibers not only are distinguished by the desired low values for the coefficients of thermal expansion but also have increased strength. Both are indicative of good fiber-matrix adhesion. This can be shown, for example, by preparing an electron micrograph of the fracture surface of connecting pieces destroyed in a tensile test or in a bending test and comparing this with a fracture surface of connecting pieces which contain fibers without such a treatment.

These findings are illustrated by the appended micro-photographs. The construction and method of the invention, together with additional objects and advantages thereof will be best understood from the following description of specific examples when read in connection with the accompanying drawings.

### BRIEF DESCRIPTION OF THE DRAWINGS

FIG. 1 is a micrograph, taken by an electron microscope, of a fracture surface of a connecting piece (connecting pin) in which carbon fibers according to the invention were used; and

FIG. 2 is a similar electron micrograph of a fracture surface of a connecting piece (connecting pin) in which carbon fibers from mesophase pitch were used as reinforcement.

### DESCRIPTION OF THE PREFERRED EMBODIMENTS

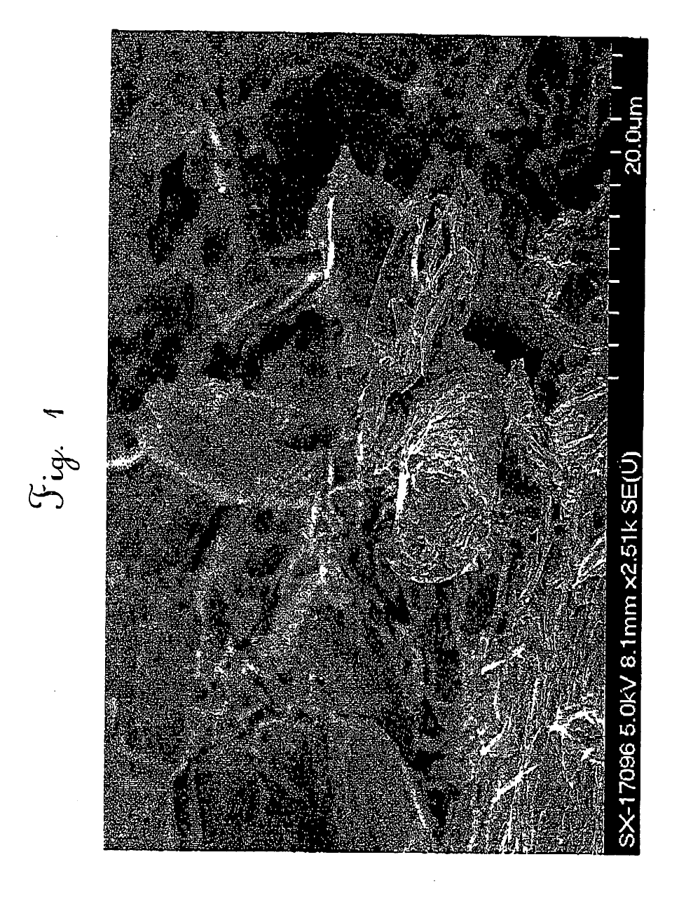

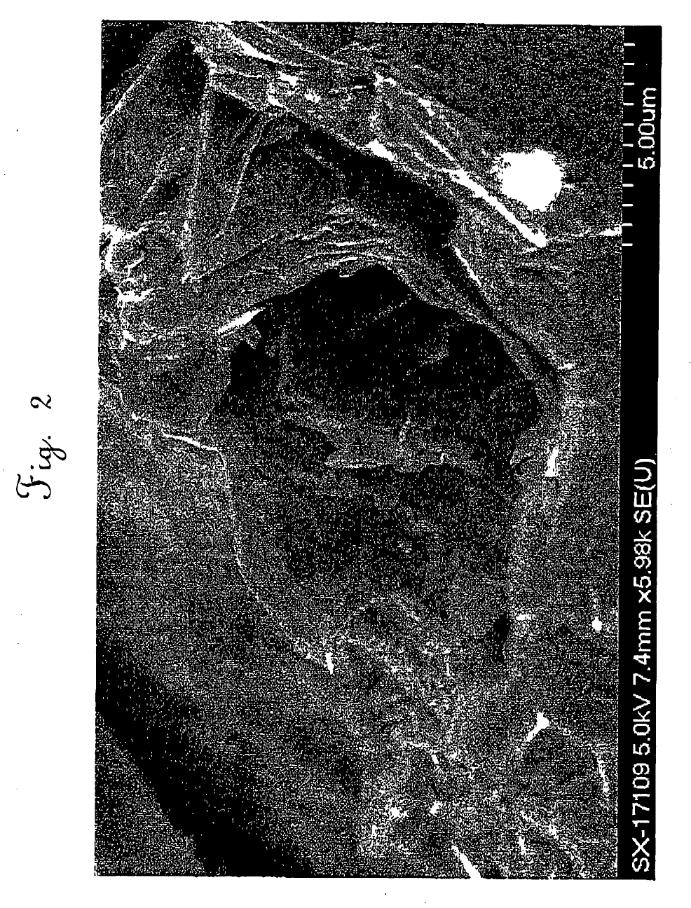

Referring now to the figures of the drawing in detail, a comparison of the two micrographs renders it immediately clear that, in the case of fibers from mesophase pitch without the treatment according to the invention (FIG. 2), the fibers are simply pulled out of the matrix in the event of a fracture and they leave behind a void, whereas, in the case of a connecting piece comprising fibers treated according to the invention by activation and coating, said fibers adhere firmly in the matrix and are not pulled out of the matrix in the event of a fracture (FIG. 1).

In a connecting piece which is produced according to the invention, the fracture surface displays matrix cracks and cracks of the fibers in the fracture surface. However, the matrix reveals no holes from which the reinforcing fibers were pulled out on failure. The adhesion of the fibers to the matrix is evidently so great that the force required for pulling the fibers out of the matrix (“pull-out”) is greater than the tensile strength of the fibers. In a comparison with a connecting piece which was produced according to the prior art using carbon fibers obtained from mesophase pitch and without the treatment according to the invention, the pull-out holes of the fibers from the fracture surface are clearly detectable.

It is furthermore surprising that, as explained above, no destruction of the fibers as a result of internal stresses occurs in spite of the presumably better binding of the fibers in the matrix due to the surface treatment.

The graphitized bodies which are produced from the materials according to the invention have the following properties:

| | | |
|---|---|---|
| Density | in kg/m³ | 1740 to 1850 |
| Modulus of elasticity* in | in GPa | 20 to 25 |
| the tensile test | | |
| Flexural strength* | in MPa | 25 to 33 |
| Resistivity* | in μΩ · m | 3.0 to 4.5 |
| Longitudinal* coefficient | in μm/(K · m) | −0.5 to 0.1 |
| of thermal expansion | | |
| Transverse coefficient of | in μm/(K · m) | 1.7 to 2.1 |
| thermal expansion | | |

*Parallel to the extrusion direction

Connecting pieces comprising these graphitized bodies lead, in a practical test, to substantially reduced susceptibility to cracking due to thermal stresses.

The invention is explained by referring to the following examples.

### EXAMPLE 1

A fiber tow (7×60,000 filaments having a fiber diameter of 7 μm) comprising carbonized polyacrylonitrile fibers was subjected to anodic oxidation. For this purpose, the fiber tow was passed through a bath having an effective length of about 1 m and containing an aqueous solution of sodium hydroxide (5 g in 100 g of the solution) at a speed of 1 m/min according to the method described in U.S. Pat. No. 4,704,196, example 3. The bath was continuously circulated. A sinusoidal voltage of 5 V was applied, and the current was about 70 A.

Thereafter, the fiber tow was washed out in a two-stage wash bath containing demineralized water and was squeezed out. The tow was then passed through a sizing bath containing 10 g of aqueous dispersed polyurethane resin in 100 g of the dispersion and having an effective length of 0.5 m, squeezed out, and dried over godets at 120° C. The fiber tow was cut to give staple fibers about 6 mm long.

### EXAMPLE 2

A molding material was prepared from:

100 kg of needle coke having a mean particle size of 0.5 mm;

26 kg of cold tar pitch having a softening temperature (SPM) of 110° C.;

3 kg of PAN-based carbonized carbon fibers having a diameter of 7 μm and an average length of 6 mm, which were anodically oxidized and provided with a polyurethane coating according to example 1; and

0.5 kg of iron oxide of pigment quality (particle size range from 0.1 to 2 μm).

The material was mixed for 0.5 hour in a kneader-mixer at 160° C., extruded at 120° C. to give a cylindrical extrudate and, after cutting to a length of about 3000 mm, combusted at 800° C. for 500 hours. The combusted cylindrical carbon bodies were then impregnated three times with an impregnating pitch (SPM 80° C.) and subsequently combusted at 800° C. The impregnated and subsequently combusted carbon bodies were graphitized in a conventional manner at about 3000° C.

The following values were measured on the cylindrical graphite bodies having a diameter of 305 mm and a length of 2300 mm (a corresponding mixture without the addition of fibers was prepared as a comparison, and the measured values for the graphite bodies produced therefrom are shown in brackets):

| | | |
|---|---|---|
| Longitudinal coefficient of | in μm/(K · m) | 0.06 (0.14) |
| thermal expansion | | |
| Transverse coefficient of | in μm/(K · m) | 1.88 (1.88) |
| thermal expansion | | |
| Flexural strength parallel to | in MPa | 28.5 (26.0) |
| the extrusion direction | | |

Although the invention is illustrated and described herein as embodied in a connecting pieces for carbon material electrodes, it is nevertheless not intended to be limited to the details shown, since various modifications and structural changes may be made therein without departing from the spirit of the invention and within the scope and range of equivalents of the claims.

This application claims the priority, under 35 U.S.C. § 119, of German patent application No. 103 12 370.9, filed Mar. 20, 2003; the disclosure of the prior application is herewith incorporated by reference in its entirety.

We claim:

1. A connecting piece for carbon material electrodes, comprising: a connecting piece body, carbon fibers in said connecting piece body, said carbon fibers having oxidatively activated surfaces, and an added carbonized coating, said carbonized coating being a carbonization product of a coating material selected from the group consisting of wax, pitch, natural resins, thermoplastic polymers, and thermosetting polymers.

2. The connecting piece according to claim 1, wherein said carbon fibers have a modulus of elasticity of from 200 to 250 GPa.

3. The connecting piece according to claim 1, wherein said carbon fibers have a linear coefficient of thermal expansion of from −0.5 to +0.1 μm/(K·m) in a direction parallel to a lateral surface thereof, and from 1.7 to 2.1 μm/(K·m) in a normal plane orthogonal thereto.

4. The connecting piece according to claim 1, wherein said carbon fibers have an average length of from 0.5 to 40 mm.

5. The connecting piece according to claim 1, wherein a mass fraction of said carbon fibers in said connecting piece body is from 0.2 to 10%.

6. The connecting piece according to claim 1, wherein a mass fraction of said carbonized coating on said carbon fibers, based on a mass of said carbon fibers, is from 0.2 to 15%.

7. The connecting piece according to claim 1, wherein said carbon fibers are fibers based on polyacrylonitrile.

8. The connecting piece according to claim 1, wherein said carbon fibers are disposed in a form selected from the group consisting of parallel filaments, woven fabrics, layered fabrics, warp-knitted fabrics, knitted fabrics, and nonwoven fabrics.

9. A method of producing connecting pieces for carbon material electrodes, the method which comprises:
activating surfaces of carbon fibers by oxidation in a first step;
subsequently coating the carbon fibers with a surface coating of a coating material selected from the group consisting of wax, pitch, natural resins, thermoplastic polymers, and thermosetting polymers, to form coated fibers;
optionally treating the coated fibers at a temperature of between 750 and 1,300° C. for carbonization of the coating;
mixing the fibers with coke having a mean particle size in a range from 0.05 to 4 mm, with pitch having a softening temperature in a range from 70° C. to 150° C., and optionally with further additives, and shaping into substantially cylindrical form bodies;
carbonizing and then graphitizing the substantially cylindrical form bodies; and
turning the graphitized form bodies to form connecting pieces with threads.

10. The method according to claim 9, which comprises using carbon fibers in a form of a fiber tow comprising from 1000 to 60,000 individual filaments, and, prior to the mixing step, cutting the fibers to form short fibers having an average length of from 0.5 to 40 mm.

11. The method according to claim 9, which comprises using carbon fibers in a form of heavy tow fibers comprising from 40,000 to 2,000,000 individual filaments and, prior to the mixing step, cutting the heavy tow to form short fibers having an average length of from 0.5 to 40 mm.

12. The method according to claim 9, which comprises activating the carbon fibers in an aqueous bath containing an oxidizing agent.

13. The method according to claim 9, which comprises activating the carbon fibers in an aqueous bath by anodic oxidation.

14. The method according to claim 9, which comprises activating the carbon fibers in a gas stream containing an oxidizing agent.

15. The method according to claim 9, wherein the coating step comprises coating the activated carbon fibers in an aqueous or solvent-containing bath containing a dispersion or solution of a coating material selected from the group consisting of wax, pitch, natural resins, thermoplastic polymers, and thermo-setting polymers.

16. The method according to claim 9, which comprises treating the coated carbon fibers at a temperature of from 900 to 1,200° C. for carbonization of the coating.

17. The method according to claim 9, wherein the mixing step comprises preparing a mixture containing for each 100 kg of coke, from 10 to 40 kg of a pitch, and from 0.2 to 20 kg of carbon fibers.

18. The method according to claim 17, which comprises adding from 0.1 to 1 kg of an iron oxide pigment having a mean particle size of from 0.1 to 2 μm as a further additive.
